(19) United States
(12) Patent Application Publication
(10) Pub. No.: US 2014/0262288 A1
(43) Pub. Date: Sep. 18, 2014

(54) SILOXANE SURFACTANT ADDITIVES FOR OIL AND GAS APPLICATIONS

(71) Applicant: CESI Chemical, Inc., Marlow, OK (US)

(72) Inventors: Glenn S. Penny, Houston, TX (US); Keith Dismuke, Katy, TX (US); Richard Fox, Katy, TX (US); Andrei Zelenev, The Woodlands, TX (US); Randal M. Hill, The Woodlands, TX (US)

(21) Appl. No.: 13/831,410

(22) Filed: Mar. 14, 2013

(51) Int. Cl. C09K 8/60; E21B 43/16

(52) U.S. Cl. CPC C09K 8/602; E21B 43/16
USPC 166/307; 507/234

(57) ABSTRACT

A well treatment additive includes a siloxane surfactant, a solvent and an aqueous phase. The solvent is preferably a terpene hydrocarbon. Also disclosed is a method for using the well treatment additive to form and enhance the properties of terpene solvent based additives useful for the treatment of oil and gas wells. Methods of using the novel well treatment additives include using the additives in a variety of well treatment processes including, but not limited to, acidizing operations, hydraulic fracturing operations, well remediation operations and water removal operations.

### FIELD OF THE INVENTION

The present invention generally relates to the production of petroleum and more particularly to compositions and processes for improving the recovery of petroleum from a subterranean geological formation.

### BACKGROUND OF THE INVENTION

For many years, petroleum has been recovered from subterranean reservoirs through the use of drilled wells and production equipment. During the production of desirable hydrocarbons, such as crude oil and natural gas, a number of other naturally occurring substances may also be encountered within the subterranean environment.

The removal of unwanted deposits from the wellbore and production equipment is generally referred to as “remediation.” In contrast, the term “stimulation” generally refers to the treatment of geological formations to improve the recovery of hydrocarbons. Common stimulation techniques include well fracturing and acidizing operations. Well remediation and stimulation are important services that are offered through a variety of techniques by a large number of companies.

Oil and natural gas are found in, and produced from, porous and permeable subterranean formations. The porosity and permeability of the formation determine its ability to store hydrocarbons, and the facility with which the hydrocarbons can be extracted from the formation.

The use of certain microemulsion additives during completion of both oil and gas wells leads to higher near wellbore permeability and long-term increased production of hydrocarbons from the well. The increased displacement of water from the formation and proppant by both oil and gas (flowback) and consequent increased production of hydrocarbons have been attributed to lowered capillary pressure. However, the solvent—hydrocarbon surfactant systems that have been used have limitations in their ability to lower capillary pressure. There is, therefore, a need for treatment compositions that are capable of lowering capillary pressure and increasing wettability while maintaining the desirable properties of conventional emulsified treatment formulations.

### SUMMARY OF THE INVENTION

In preferred embodiments, the present invention includes a well treatment additive that includes a siloxane surfactant, a solvent and an aqueous phase. The solvent is preferably a terpene hydrocarbon. The well treatment additive preferably is a spontaneously formed nanofluid with a nano-sized self-assembled liquid phase.

In another aspect, the preferred embodiments include the use of siloxane surfactants (alone or in combination with conventional hydrocarbon surfactants) to form and enhance the properties of terpene solvent based nanofluid additives useful for the treatment of oil and gas wells.

In another aspect, the preferred embodiments include methods of using the novel well treatment additives in a variety of well treatment processes. Suitable well treatment processes include, but are not limited to, acidizing operations, hydraulic fracturing operations, well remediation operations and water removal operations.

### BRIEF DESCRIPTION OF THE DRAWINGS

FIG. 1 provides a graph of the surface tension of 2 gpt dispersions of siloxane surfactant containing microemulsion formulations. The squares represent formulations containing a higher level of terpene solvent while the circles represent formulations with a lower level of terpene solvent.

FIG. 2 provides a graph of the aqueous phase displacement by gas for a siloxane surfactant additive during an upflow experiment using 20/40 mesh Ottawa sand.

FIG. 3 provides a graph of aqueous phase displacement by Eagle Ford condensate for two siloxane surfactant microemulsion products compared with two existing commercial microemulsion products in a downflow experiment using 70/140 Ottawa Sand.

FIG. 4 provides a graph of particle size distribution for a 2 gpt dispersion of Formulation A in 2% KCl brine. The formulation disperses to a narrow single distribution of very small nanodroplets.

### DETAILED DESCRIPTION OF PREFERRED EMBODIMENTS

Presently preferred embodiments generally contemplate the preparation of an additive for use in oil and gas wells. The additive preferably includes a solvent component, a surfactant component and an aqueous phase. In a particularly preferred embodiment, nano-sized particles of the solvent component are distributed within the aqueous phase. Other functional materials may also be included advantageously.

Generally, the additive is prepared using a siloxane surfactant, a solvent and an aqueous phase. In more particularly preferred embodiments, the solvent is a terpene and the surfactant includes a combination of a siloxane surfactant and a hydrocarbon surfactant of a kind, amount and proportion effective to form a stable distribution of the nano-sized particles of terpene solvent within the aqueous phase. Each of these components is discussed separately below.

As used herein, the term “siloxane surfactant” refers to permethylated siloxane materials functionalized with a sufficient number of polar groups so as to render them usefully surface active in aqueous mixtures. Thus, these siloxane surfactants qualify as amphiphiles in which a hydrophobic silicone group is coupled with one or more hydrophilic groups. They may be co-polymers, or molecules comparable in molecular weight to conventional organic surfactants such as heptaethylene glycol monododecyl ether.

To facilitate description of preferred siloxane surfactants, it is helpful to use the MDTQ notation for siloxane copolymers adopted in U.S. Pat. No. 3,299,112 issued Jan. 17, 1967 to Bailey, and summarized in Table 1 below:

TABLE 1
MDTQ Notation for Siloxane Building Block Units

| | | |
|---|---|---|
| M | Me₃SiO_{1/2}— | A trimethyl end-cap unit |
| D | —Me₂SiO— | The basic dimethyl unit |
| T | —MeSiO_{3/2}— | A three-way branch point unit |
| Q | —SiO₂— | A four-way branch point unit |
| M′ | Me₂(R)SiO_{1/2}— | A substituted trifunctional end-cap unit |
| D′ | —Me(R)SiO— | A substituted difunctional unit |
| T′ | —RSiO_{3/2}— | A substituted three-way branch point unit |
| Me | —CH₃ | |
| | H, or | (after hydrosilylation) some non-methyl |
| | | organic group such as |
| R | | —CH₂CH₂CH₂(OCH₂CH₂)ₙOH |

It should be noted that while an organic radical, R, is implicit in the M′D′T′ notation, the R group is shown in the structures given below to permit a more detailed disclosure of the range of structures of R groups useful within the siloxane surfactant component.

In presently preferred embodiments, the siloxane surfactant component is an organosilicon compound having a formula selected from the group consisting of one of the formulas identified in Table 2 below:

| | | |
|---|---|---|
| 1. | MDa(D′R1)bM | a graft-type copolymer |
| 2. | (M′R1)Da(M′R1) | an ABA-type copolymer |
| 3. | (M′R1)Da(M′R2) | an AB-type copolymer |
| 4. | (M′R1)Da(D′R1)b(M′R1) | a hybrid graft-type, ABA-type copolymer |
| 5. | Tz(T′R1)c | a silsesquioxane cage structure |
| 6. | (M′R1)tMuQv | a functionalized MQ silicone resin |
| 7. | [(D′R1)Dk] | a cyclic siloxane (the square brackets |
| | | denote a cyclic structure) |

where R1 represents an organic radical comprising —(CH2)n-OCH2CH2)x-(OCH(CH3)CH2)y-OR3, in which n = 3 to about 11, x = 3 to about 30, y = 1 to about 30, and R3 may be —H, —Me, or —C(O)CH3.

For formula 1, a is 0-200, and b is 1-20. The case for which a=0 and b=1 represents the heptamethyltrisiloxane surfactants. Suitable examples are available from Dow Corning Corporation as Dow Corning® Q2-5211 Superwetting Agent, or from Momentive™ as Silwet L-77. For formula 2, a is 4-50. A suitable example available from Dow Corning Corporation is Dow Corning® 2-8692 Fluid. For formula 3, a is 0-25, and R2 represents an alkane radical of 1-8 carbon atoms. For formula 4, a is 0-200, and b is 1-20. For formula 5, the ratio of c:z is 1:7 to 2:6, and the total molecular weight should be less than 7000 Daltons. For formula 6, the ratio of (t+u):v is from 0.4:1 to 2:1 and the ratio of t:u is from 1:4 to 1:1, and the total molecular weight should be less than 7000 Daltons. For formula 7, k is 4-5.

Suitable hydrocarbon surfactants include a multiplicity of surface active agents which are expediently classified into nonionic, anionic, cationic and amphoteric surface-active agents. An overview is cited in Ullmanns Encyklopadie der technischen Chemie [Ullmanns Encyclopedia of Industrial Chemistry], Verlag Chemie Weinheim, 4th Edition 1975, Volume 10, pp. 449-473.

In a presently preferred embodiment, the additive comprises one or more nonionic surfactants, cationic surfactants, anionic surfactants, zwitterionic surfactants, or combinations thereof. Surfactants in general are wetting agents that lower the surface tension of a liquid in which they are dissolved, allowing easier spreading and decreasing the interfacial tension between two liquids. Each surfactant has a hydrophilic head that is attracted to water molecules and a hydrophobic tail that repels water and attaches itself to hydrophobic materials such as oil and grease.

In a particularly preferred embodiment, the additive comprises a non-ionic surfactant. In this context, a nonionic surfactant has an uncharged hydrophilic head and a hydrophobic tail comprising a carbon chain. Examples of nonionic surfactants suitable for use in this disclosure include without limitation linear alcohol ethoxylates, polyoxyethylene alkylphenol ethoxylates, polyoxyethylene alcohol ethoxylates, polyoxyethylene esters of fatty acids, polyoxyethylene alkylamines, alkyl polyglucosides, ethylene oxide-propylene oxide copolymers or a combination thereof. Particularly useful nonionic surfactants may have a carbon chain length of 8-20 carbon atoms and 3-40 ethylene oxide units, up to 40 propylene oxide units, up to 2 glucose units or a combination thereof.

In a yet another preferred embodiment, the nonionic surfactant may be present in the additive in an amount of from about 5 wt. % to about 70 wt. % based on the total weight of the additive, and more preferably from about 10 wt. % to about 70 wt. %, and even more preferably from about 20 wt. % to about 40 wt. %.

In yet another preferred embodiment, the additive comprises an anionic surfactant. In this context, an anionic surfactant has a negatively charged head and a hydrophobic tail comprising a carbon chain. Examples of anionic surfactants suitable for use in this disclosure include without limitation sodium salts of fatty acids, alkyl sulphates, alkyl ethoxylate sulphates or sulfonates, or a combination thereof. Preferred anionic surfactants may have a carbon chain length of 8-20 carbon atoms.

In yet another preferred embodiment, the additive comprises a cationic surfactant. In this context, a cationic surfactant has a positively charged head and a hydrophobic tail comprising a carbon chain. Examples of cationic surfactants suitable for use in this disclosure include without limitation quaternary ammonium salts, ethoxylated quaternary ammonium salts, or a combination thereof. A preferred cationic surfactant may have a carbon chain length of 8-20 carbon atoms

In yet another preferred embodiment, the additive comprises a zwitterionic surfactant. Zwitterionic surfactants are electrically neutral surfactants that carry both a formal positive and a formal negative charge on different atoms in the same molecule. Examples of zwitterionic surfactants suitable for use in this disclosure include without limitation alkyl amine oxides, alkyl betaines, alkyl amidopropyl betaine, alkyl sulfobetaines, alkyl sultaines, or combinations thereof. A particularly preferred zwitterionic surfactant may have a carbon chain length of 8-20 carbon atoms

Surfactants can be described in terms of their hydrophile-lipophile balance (HLB) numbers, or silicone HLB (SHLB) numbers for siloxane surfactants, but the formulation of a microemulsion requires that the surfactant system be matched to, and optimized for the particular oil or solvent in use. It has been determined that the best procedure for selecting and optimizing a surfactant system is to map the phase behavior and select the system that gives the desired stability over a wide range of temperatures.

The solvent component is preferably selected from the class of solvents referred to as terpenes, including those derived from citrus and from pine sources. Terpene solvents are natural products, whose structures are built up from isoprene units. A dimer consisting of two isoprene units is termed a monoterpene. They can be acyclic or cyclic. The broader term “terpenoids” also covers natural and synthetic derivatives such as alcohols, aldehydes, ketones, and ethers. Particularly preferred terpenes include cyclic and acyclic monoterpenoids, including but not limited to those that are good solvents for paraffins and asphaltenes.

The additive optionally includes a co-solvent or mixture of co-solvents. Co-solvents increase the usefulness of additives, especially freeze stability. Preferred co-solvents include short chain alkyl alcohols and glycols and combinations thereof. Particularly preferred co-solvents include methanol, ethanol, isopropanol, 1,2-pentanediol, propylene glycol, and triethylene glycol and combinations thereof.

In a preferred embodiment, the co-solvent may be present in the additive in an amount of from about 5 wt. % to about 70 wt. % based on the total weight of the additive, more preferably from about 10 wt. % to about 70 wt. %, and even more preferably from about 20 wt. % to about 40 wt. %. Alternatively, the co-solvents are incorporated into the additive to provide a formulation that is clear and stable over a temperature range from −25 degrees F. to 150 degrees F.

A series of laboratory tests confirms the superior effectiveness of the additives incorporating siloxane surfactants. It has been determined that mixtures of siloxane surfactants and hydrocarbon surfactants can markedly lower surface tension to values not achievable by the hydrocarbon surfactants alone. In addition, and unexpectedly since silicone materials are usually regarded as incompatible with hydrocarbon materials, the additives of the preferred embodiments have been found to exhibit improved aqueous phase (brine) displacement by crude oil or gas.

Within these laboratory tests, a first series of additives was prepared using a siloxane surfactant, a co-solvent, aqueous phase and a terpene solvent. A second series of additives was prepared using a siloxane surfactant, a hydrocarbon surfactant, a co-solvent, an aqueous phase and a terpene solvent. The following examples provide performance characteristics for the first and second series of additives.

### Example 1

A transparent low-viscosity mixture that exhibited the characteristic properties of a microemulsion was prepared using 60% by weight of a 1:1 blend of Dow Corning Xiameter® OFX-0190 Fluid (siloxane surfactant) and isopropyl alcohol (co-solvent), 30% by weight of water (aqueous phase), and 10% by weight of technical grade d-limonene (terpene solvent). This mixture was identified as a microemulsion based on the spontaneous formation with minimal mechanical energy input to form a transparent dispersion from an immiscible mixture of water and d-limonene upon addition of an appropriate amount of surfactant and co-solvent. These and other salient characteristics identifying a mixture as a spontaneously formed microemulsion are well-known to practitioners in the art.

The order of mixing of this and other compositions described in this disclosure is not critical, but for convenience during the laboratory tests, the additives were prepared using a procedure in which a mixture of the surfactant and the isopropyl alcohol was first prepared and then combined with a mixture of the technical grade d-limonene and water. With small samples in the laboratory, a few seconds of gentle mixing yielded a transparent dispersion. It will be understood by experts on liquid mixing that longer times are required in the large vessels used in full-scale commercial manufacturing.

### Example 2

A transparent low-viscosity additive was prepared using 30% by weight of a 1:1 blend of Dow Corning® 5211 Superwetting Agent (siloxane surfactant) and isopropyl alcohol (co-solvent), 60% by weight of water (aqueous phase), and 10% by weight of technical grade d-limonene (terpene solvent).

### Example 3

A transparent low-viscosity additive was prepared using about 61% by weight of a blend of a detergent range alcohol ethoxylate surfactant, an ethoxylated castor oil surfactant, isopropyl alcohol and glycol co-solvent, about 2% by weight of Momentive™ Silwet L-77 siloxane surfactant, 15% by weight of water, and 22% by weight of technical grade d-limonene. This is the formulation referenced as Formulation 3B below. Additional transparent low-viscosity additives were prepared increasing the siloxane surfactant up to 12% by weight of Momentive™ Silwet L-77 (and 51% by weight of the other surfactant/co-solvent components). This is the formulation designated as 4B below.

### Example 4

A transparent low-viscosity additive was prepared using about 41% by weight of a blend of a detergent range alcohol ethoxylate surfactant, an ethoxylated castor oil surfactant, isopropyl alcohol and glycol co-solvent, about 12% by weight of Momentive™ Silwet L-77 siloxane surfactant, 41% by weight of water, and 6% by weight of technical grade d-limonene. Several additional formulations similar to this were prepared with varying amounts of siloxane surfactant. These are the microemulsion formulations shown in FIG. 1 with a lower level of terpene solvent.

To characterize the interfacial and performance characteristics of these additives, 2 gallons per thousand (gpt) dilutions were prepared. The surface tension of the 2 gpt dilution was measured using a properly calibrated Kruss K100 tensiometer. The surface tension results for the formulations described under Example 3 are shown in FIG. 1. As FIG. 1 demonstrates, incorporation of the siloxane surfactant into these microemulsion formulations produced a progressive decrease in the surface tension, ultimately reaching values below 22 mN/m—much lower than common hydrocarbon surfactants, which typically give surface tension values greater than 28 mN/m.

Contact angles of 2 gpt dilutions were measured on dry-polished shale core samples from the Niobrara formation. For commercially available microemulsion products, initial contact angle values for 2 gpt dilutions are around 30-40 degrees with rapid relaxation to stable values of 9-15 degrees within 30 seconds. For the formulations shown in FIG. 1, all except the 0% siloxane surfactant gave contact angles of zero degrees (hence complete wetting) after 6-20 seconds. This demonstrates the remarkable ability of the microemulsion incorporating this siloxane surfactant to produce complete wetting of mixed-wet formation rock surfaces even for small proportions of the siloxane surfactant in the formulation. Decreasing the contact angle from 9 degrees to zero degrees increases the capillary pressure slightly, but even a small decrease in the surface tension from 29 to 28 mN/m more than offsets this slight increase (assuming a 10 micron pore diameter, capillary pressure Pc=0.831 psi for a surface tension of 29 mN/m and contact angle of 9 degrees, and Pc=0.812 psi for 28 mN/m and zero degrees). Thus the combination of surface tension lowering and increased wetting would be expected to lead to an increase in near wellbore conductivity.

FIG. 2 shows the efficacy of one of the low terpene solvent formulations from FIG. 1 in promoting brine displacement by gas. A 2 gpt dispersion of this formulation gave a surface tension of 25.8 mN/m.

Surface tensions of the 2 gpt dispersions were measured before and after they passed through the sand pack to determine how much of the surfactant was lost to adsorption during the experiment. An increase of surface tension of 1-3 mN/m was typically observed. In the case of the formulation shown in FIG. 2 the increase was <1 mN/m. In comparison, a surfactant package widely used in the oilfield exhibited an increase in surface tension of >20 mN/m, often up to 40 mN/m (representing essentially complete loss of all surfactant due to adsorption).

FIG. 3 shows the progression in performance enhancement from an all-hydrocarbon microemulsion formulation with increasing level of siloxane surfactant. Formulation 3B gave a surface tension of 28 mN/m, while 4B gave a surface tension value of 24.5 mN/m. Both siloxane surfactant formulations perform better than the commercial products. Thus, combining the siloxane surfactant with the hydrocarbon surfactant and the terpene solvent yields a microemulsion formulation with much improved performance.

### Example 5

An additive was prepared using a combination of Dow Corning Xiameter® OFX-0190 Fluid (siloxane surfactant) with a detergent grade alcohol ethoxylate surfactant and d-limonene as the solvent, and its performance compared with that of the hydrocarbon surfactant. The ratio of the siloxane surfactant to the detergent grade alcohol ethoxylate (hydrocarbon) surfactant is 1:4 (by weight). FIG. 4 shows the particle size distribution of a 2 gpt dispersion of Formulation A into 2% KCl brine. The additive disperses to a narrow single distribution of very small nanodroplets, easily small enough to be compatible with the pore size of even low permeability tight shale gas formations. This formulation gave 87% aqueous phase displacement by condensate, and 73% aqueous phase displacement by gas (upflow).

### Example 6

A further demonstration of the efficacy of a microemulsion prepared by combining a higher HLB highly efficient siloxane surfactant with a hydrocarbon surfactant and a terpene solvent. The siloxane surfactant had an HLB value of 13.2 and was combined with a detergent grade alcohol ethoxylate surfactant and d-limonene as the terpene solvent. Formulation 1 was prepared with a 1:1 ratio of water to terpene solvent, while Formulation 2 was prepared with a 6.5:1 ratio of water to terpene solvent. In both formulations, the surfactant mixture and concentration were identical. The surface tensions of both formulations before passing through the sand pack were about 21 mN/m. After contacting the sand pack the surface tensions increased 2-4 mN/m for the first pore volume, and negligible increase for the third pore volume. Both formulations reached excellent Eagle Ford condensate displacement values of about 90%—slightly better than the siloxane surfactant formulations shown in FIG. 3, and much better than the commercial microemulsion products shown in FIG. 3. These formulations achieved gas displacement values of 69-76% (see FIG. 2 for experimental details).

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed and as defined in the written description and appended claims.

It is claimed:

1. A well treatment additive comprising:
a siloxane surfactant;
a solvent, wherein the solvent is a terpene hydrocarbon; and
an aqueous phase.

2. The well treatment additive of claim 1, further comprising a co-solvent.

3. The well treatment additive of claim 2, wherein the co-solvent is selected from the group consisting of alkyl alcohols containing from 1 to 4 carbon atoms, oligo-oxyalkylenes containing from 1 up to 3 units of ethylene oxide, and oligo-oxyalkylenes containing from 1 up to 3 of propylene oxide.

4. The well treatment additive of claim 1, further comprising a hydrocarbon surfactant, wherein the siloxane surfactant is a minimum of 2%, a maximum of 60% with a preferred range of 10-15%, with 10% most preferred, and a hydrocarbon surfactant with a minimum of 0%, a maximum of 35% with a preferred range of 10-35% with the most preferred being 25%, and the aqueous phase being a minimum of 15% and a maximum of 93%.

5. The well treatment additive of claim 4, wherein the hydrocarbon surfactants are selected from the group consisting of polyoxyethylene alky ethers, dialkyl sulfosuccinates, ethylene oxide propylene oxide copolymers, alkyl sulfates, sulfonates, carboxylates, amine oxides, primary alkylamines, dialkyl secondary amines, ethoxylated fatty amines, and combinations thereof.

6. The well treatment additive of claim 1, wherein the well treatment additive comprises about 5-40% by weight of terpene hydrocarbon.

7. The well treatment additive of claim 6, wherein the well treatment additive comprises about 10-15% by weight of terpene hydrocarbon.

8. The well treatment additive of claim 1, wherein the siloxane surfactant is a siloxane polyalkylene oxide copolymer.

9. The well treatment additive of claim 1, wherein the siloxane surfactant has a formula selected from the following formulas:
MDa(D′R1)bM, (M′R1)Da(M′R1), (M′R1)Da(M′R2), (M′R1)Da(D′R1)b(M′R1), Tz(T′R1)c, (M′R1)tMuQv, [(D′R1)Dk];
wherein “R1” represents an organic radical comprising —(CH2)n-(OCH2CH2)x-(OCH(CH3)CH2)y-OR3, in which “n” is between 3 and 11, “x” is between 3 and about 30, “y” is between 1 and 30, and “R3” is selected from the group consisting of —H, —Me, and —OC(O)CH3;
wherein “M” represents Me3SiO1/2, D represents —Me2SiO—, “T” represents —MeSiO3/2-, “Q” represents —SiO2-, “MT” represents
Me2(R)SiO1/2-, “DT′” represents —Me(R)SiO—, “T′” represents —RSiO3/2-, “Me” represents —CH3, and “R” represents H; and
wherein “a” is 0-200.

10. The well treatment additive of claim 9, wherein the siloxane surfactant is a trisiloxane ethoxylate graft-type copolymer where a=0.

11. A method of treating the near-wellbore region of a subterranean formation in a well comprising:
providing an additive, wherein the additive comprises:
a siloxane surfactant;
a hydrocarbon surfactant;
a co-solvent;
a terpene solvent, and
an aqueous phase;
diluting the additive with a carrier fluid to a concentration of about 0.05-5 weight % of additive to carrier fluid;
introducing the diluted additive into the well;
allowing the dilution of the additive to contact the formation and proppant; and
leaving the treatment in the well to increase water displacement from the formation by both oil and gas.

12. The method of claim 11, wherein the diluted additive is pumped into the well in combination with proppant during a hydraulic fracturing operation.

13. The method of claim 11, wherein the diluted additive is pumped into the well at a high rate water pack with friction reducer.

14. The method of claim 11, wherein the diluted additive is pumped into the well in combination with a selected acid during an acidizing treatment.

15. The method of claim 11, wherein the step of providing an additive further comprises providing an additive with about 5-40 by weight % terpene solvent.

16. The method of claim 11, wherein the step of providing an additive further comprises providing an additive in which the co-solvents comprise alkyl alcohols containing from 1 to 4 carbon atoms, oligo-oxyalkylenes containing from 1 up to 3 units of ethylene oxide, and oligo-oxyalkylenes containing from 1 up to 3 of propylene oxide.

17. The method of claim 11, wherein the step of providing an additive further comprises providing an additive in which the siloxane surfactant is selected from the group of siloxane polyalkylene oxide copolymers.

18. The method of claim 11, wherein the step of providing an additive further comprises providing an additive in which the hydrocarbon surfactants are selected from the group consisting of polyoxyethylene alky ethers, dialkyl sulfosuccinates, ethylene oxide propylene oxide copolymers, alkyl sulfates, sulfonates, carboxylates, amine oxides, primary alkylamines, dialkyl secondary amines, ethoxylated fatty amines, and combinations thereof.
